(19) United States
(12) Patent Application Publication
(10) Pub. No.: US 2025/0208595 A1
(43) Pub. Date: Jun. 26, 2025

(54) SAFETY VERIFICATION FOR PROGRAMMABLE LOGIC DEVICES, AND RELATED METHODS, APPARATUSES, AND SYSTEMS

(71) Applicant: Microsemi SoC Corp., Chandler, AZ (US)

(72) Inventor: Greg Mears, Palatine, IL (US)

(21) Appl. No.: 18/990,829

(22) Filed: Dec. 20, 2024

Related U.S. Application Data
(60) Provisional application No. 63/613,261, filed on Dec. 21, 2023.

(51) Int. Cl. G05B 19/05

(52) U.S. Cl. CPC G05B 19/058; G05B 19/054; G05B 2219/13187

(57) ABSTRACT

An apparatus comprises a programmable logic device including programmable logic elements. The programmable logic elements are configurable to implement functions according to configuration data stored in non-volatile memory cells of the programmable logic elements. The programmable logic device to store a digest value in memory, the digest value at least partially based on the configuration data stored in the non-volatile memory cells. The programmable logic service is also to perform an integrity check to verify whether a currently computed digest value matches the digest value, the currently computed digest value at least partially based on current configuration data stored in the non-volatile memory cells; read the digest value; determine a check value at least partially based on the digest value; and provide the check value at an output of the programmable logic device. The check value may be provided at the output for verification at a verification circuit.

### CROSS-REFERENCE TO RELATED APPLICATION

This application claims the benefit under 35 U.S.C. § 119 (e) of U.S. Provisional Patent Application Ser. No. 63/613,261, filed Dec. 21, 2023, the disclosure of which is hereby incorporated herein in its entirety by this reference.

### TECHNICAL FIELD

Examples relate, generally, to programmable logic devices, such as Field-Programmable Gate Arrays (FPGAs) and programmable System-on-a-Chip (SoC) devices, and more particularly to safety verification of non-volatile or flash FPGAs, or non-volatile or flash programmable SoCs, for safety-critical applications. Additionally, methods, apparatuses, and systems are disclosed.

### BACKGROUND

A Field-Programmable Gate Array (FPGA) includes logic blocks configurable to implement functions according to configuration data stored in memory elements of the logic blocks. The memory elements may be non-volatile memory cells. Such an FPGA may be referred to as a “non-volatile FPGA,” a “flash FPGA,” or a “flash-based FPGA.” The use of non-volatile memory to store the configuration data allows the flash FPGA to be programmed and reprogrammed by loading new programming data into the non-volatile memory. Thus, the functionality of the flash FPGA can be changed without having to physically alter circuitry in the FPGA. As is apparent, flash FPGAs are highly flexible and adaptable to different applications or systems. For some applications, however, flash FPGAs can be perceived to be unreliable due to susceptibilities that can lead to, for example, uncertain data storage.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 depicts a non-volatile cell that may be used for flash memory;

FIG. 2 depicts a Static Random-Access Memory (SRAM) cell that may be used for volatile memory;

FIG. 3 is a schematic block diagram of an apparatus comprising a programmable logic device including a safety verification mechanism, according to one or more examples;

FIG. 4 is a flowchart of a method of safety verification for a programmable logic device, according to one or more examples;

FIG. 5 is a system including a programmable logic device having a safety verification mechanism, according to one or more examples;

FIGS. 6A and 6B are schematic diagrams an apparatus comprising a programmable logic device including a safety verification mechanism, according to one or more examples;

FIG. 7 is a process flow diagram of a process flow for reading a digest value stored in a programmable logic device, according to one or more examples;

FIG. 8A is a graph of measured operating signals of a programmable logic device configured without safety verification;

FIG. 8B is a graph of measured operating signals of a programmable logic device configured with safety verification, according to one or more examples; and

FIG. 9 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

A programmable logic device includes programmable logic elements configurable to define or implement functions (e.g., various logic functions) according to configuration data. For example, a Field-Programmable Gate Array (FPGA) includes logic blocks configurable to implement functions according to configuration data stored in memory elements of the logic blocks. The memory elements may be non-volatile memory cells. Such an FPGA may be referred to as a “non-volatile FPGA,” a “flash FPGA,” or a “flash-based FPGA.”

The use of non-volatile memory to store the configuration data allows a flash FPGA to be programmed and reprogrammed by loading new programming data into the non-volatile memory. Thus, the functionality of a flash FPGA can be changed without having to physically alter circuitry in the FPGA. As is apparent, a flash FPGA is highly flexible and adaptable to different applications or systems. The configuration data persists in the non-volatile memory even when power of the flash FPGA is removed or lost. The flash FPGA is able to power up relatively quickly when the system is restarted, as the non-volatile memory cells hold the configuration data.

In contrast to flash FPGAs, SRAM FPGAs use SRAM cells to store the configuration data. The SRAM cells are volatile memory cells, so the configuration data is lost when power is removed. When power is restored, the SRAM-based FPGA needs to reload the configuration data (e.g., via a serial interface or the like).

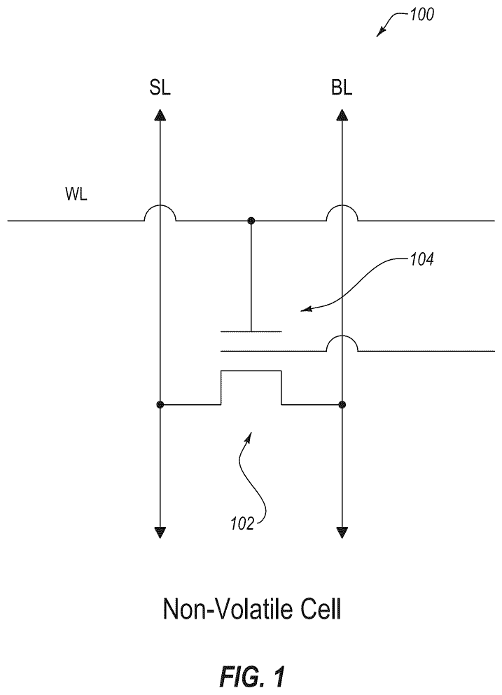

FIG. 1 depicts a non-volatile cell 100 that may be used in flash memory (e.g., in flash FPGAs). In FIG. 1, non-volatile cell 100 is a NAND-type flash memory cell, which is considered to be a type of charged-based cell. Non-volatile cell 100 comprises a transistor 102 including a source (or drain) coupled to a source line (SL), a drain (or source) coupled to a bit line (BL), and a floating gate 104 coupled to a word line (WL). Floating gate 104 stores a data bit by trapping electrons, for example, where a charged floating gate represents a logical ‘0’ and an uncharged floating gate represents a logical ‘1.’

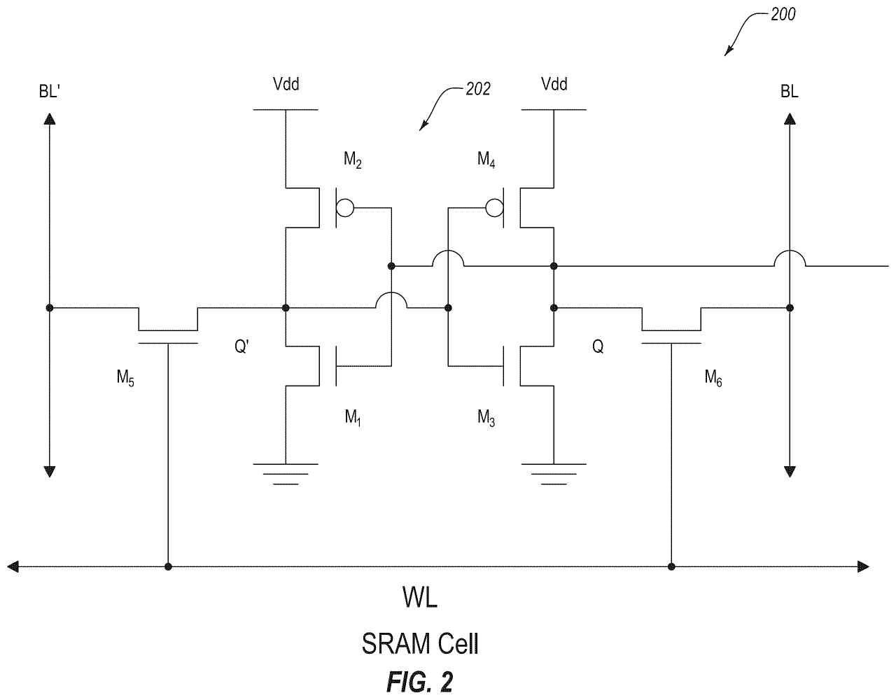

FIG. 2 depicts an SRAM cell 200 that may be used for volatile memory (e.g., in SRAM FPGAs). SRAM cell 200 comprises a latch circuit 202 having cross-coupled inverters M₁, M₂ and M₃, M₄ and access transistors M₅ and M₆. The arrangement depicted may be considered to be equivalent to a flip flop circuit, which has the ability to store information (e.g., a logical ‘0’ or ‘1’) in a stable state so long as power is supplied to the system. In FIG. 2, an input signal (e.g., Q) of inverter M₁, M₂ is linked to an output of inverter M₃, M₄, and conversely, an input signal (e.g., Q′) of inverter M₃, M₄ is linked to an output of inverter M₁, M₂. Access transistors M₅ and M₆ serve as switches driven by a word line WL, which simultaneously polarizes the gates of respective access transistors M₅ and M₆, and allows two bit lines BL and BL′ to read the stored information.

Despite many benefits, flash FPGAs can be perceived to be unreliable for some applications due to susceptibilities that can lead to, in some instances, uncertain data storage. In some instances, bit errors in flash FPGAs can occur due to the inherent physical structure of the NAND-type flash memory cell (e.g., FIG. 1). The structure of the NAND-type flash memory cell makes flash memory susceptible to a variety of factors, including charge leakage, cell-to-cell interference, and degradation due to repeated programming and erasing cycles. These susceptibilities can lead to conditions where, in some instances, bits can “flip” unintentionally. Mitigating approaches are often used in flash FPGAs to reduce or prevent such bit errors from becoming functional errors.

Like many types of devices, flash FPGAs may also be subject to tampering by malicious actors intent on reading and modifying the configuration data. It is generally difficult for malicious actors to read and modify the configuration data in a flash FPGA as the data is located on-chip. Security features can be provided in flash FPGAs to detect, prevent, and/or frustrate configuration data tampering. One security feature is a tamper detection security feature used to detect unauthorized modifications to the configuration data. Even with security features, however, advanced physical attacks by malicious actors could still possibly result in a modification of the configuration data.

Due to at least some of the above, flash FPGAs may not be selected for use in certain applications. For example, flash FPGAs are typically not used in safety-critical applications. In fuze applications for munitions, for example, there is a requirement for a fuze to be kept safe until commanded to activate. In munitions, there are multiple groups worldwide that regulate or supervise approvals of circuits and memory verifications. Currently, fuze applications make use of antifuse FPGAs and ASICs designed to be safe from the perspectives of both technology and logic. In some cases, however, there are development and cost issues associated with antifuse technologies. In the medical technology industry, medical devices or equipment require safe operation. For example, an infusion pump that operates to deliver fluids (e.g., including nutrients and medications) in controlled amounts into a patient's body would need to operate in a safe manner.

Given the many advantages of flash FPGAs, it would be advantageous if flash FPGAs were provided with safety mechanisms to verify proper flash FPGA configuration and to help prevent and/or provide assurance against any potential uncertain operation.

According to one or more examples of the disclosure, an apparatus comprises a programmable logic device having a safety verification mechanism. The programmable logic device includes programmable logic elements configurable to implement functions (e.g., logic functions) according to configuration data. The configuration data is stored in non-volatile memory cells of the programmable logic elements. In response to a programming of the configuration data in the non-volatile memory cells, a digest value is computed based on the configuration data and stored in memory.

In response to power-up (or other trigger), the programmable logic device is to perform an integrity check to verify whether a currently computed digest value matches the digest value. In one or more examples, the integrity check is a (e.g., built-in, internal) security feature (e.g., a tamper detection security feature) of the programmable logic device. In the integrity check, the currently computed digest value is computed at least partially based on current configuration data stored in the non-volatile memory cells.

In response to a verification of a match between the currently computed digest value and the digest value, the programmable logic device proceeds to perform actions for an external validation. Here, the programmable logic device proceeds to read the digest value, determine a check value at least partially based on the digest value, and provide the check value at an output. In response to a failure in the verification, the programmable logic device refrains from performing the actions for external validation.

In one or more examples, in computing the digest value and/or the currently computed digest value, the programmable logic device computes a secure hash algorithm (SHA) value based on a SHA cryptographic hash function on the configuration data stored in the non-volatile memory cells. In determining the check value, the programmable logic device computes a cyclic redundancy check (CRC) value based on the digest value. As an alternative, the programmable logic device selects one or more prespecified portions (e.g., a truncated portion) of the digest value as the check value.

In one or more other examples, the safety verification mechanism is performed in relation to two (2) digest values (e.g., two (2) SHA-256 values): a first digest value associated with the non-volatile memory cells of the programmable logic elements, and a second digest value associated with user configuration data stored other non-volatile memory. Here, a single check value (e.g., a single CRC-16 value) for verification may be calculated based on the two (2) digest values.

In one or more examples, the programmable logic device may initiate the actions of the safety verification mechanism responsive to one or more of the following triggers: a power-up of the programmable logic device or a system including the programmable logic device; respective timeouts of a periodic timer of the programmable logic device; a signal received at an external pin of the programmable logic device; an instruction of a communication received at a port of the programmable logic device.

In one or more examples, the programmable logic device is part of a system including a verification circuit operably coupled to the programmable logic device. The system may be associated with one of a variety of different types of applications (e.g., a safety-critical application). In general, the programmable logic device is configurable to implement functions according to the configuration data stored in the non-volatile memory cells to operate or operate with an electronic circuitry or component of the system. In the safety verification, the programmable logic device provides the check value at its output for verification at the verification circuit.

In one or more examples, the electronic circuitry or component of the system is enabled for operation (e.g., normal system operation) at least partially responsive to receiving an enable signal from the verification circuit (e.g., where the enable signal indicates verification of a match between the check value and a stored check value). The electronic circuitry or component of the system is not enable for operation at least partially responsive to not receiving the enable signal from the verification circuit.

In one or more other examples, the programmable logic device is to operate or operate with the electronic circuitry or component of the system (e.g., normal system operation) at least partially responsive to receiving an enable signal from the verification circuit (e.g., where the enable signal indicates verification of a match between the check value and a stored check value). The programmable logic device is prevented from operating or operating with the electronic circuitry or component of the system at least partially responsive to not receiving the enable signal from the verification circuit.

In one or more examples, the programmable logic device including the safety verification mechanism may be suitable for use in a safety-critical device or equipment including the verification circuit. The verification circuit is to enable operation (e.g., normal device operation) of the safety-critical device or equipment at least partially based on verification of the check value, or to refrain from enabling operation of the safety-critical device or equipment based on lack of verification of the check.

In one or more specific examples, the safety verification mechanism allows flash FPGAs to be suitable for use in fuzes in munitions applications. Safety is a primary concern for these types of applications, and providing a solution that meets such safety requirements allows flash FPGAs, with their associated advantages, to be more widely used. See, e.g., U.S. Department of Defense Fuze Engineering Standardization Working Group (FESWG), JOTP-051, “Technical Manual for the Use of Logic Devices in Safety Features,” February 2012, where JOTP refers to the Joint Ordinance Test Procedure.

In one or more other specific examples, the safety verification mechanism allows flash FPGAs to be suitable for use in medical devices or equipment. In one or more examples, a safety verification mechanism of the programmable logic device is to enable operation (e.g., normal device operation) of the medical device or equipment based on verification of the check value from the programmable logic device, or to refrain from enabling operation based on lack of verification. In a specific, non-limiting example, the medical device or equipment including the programmable logic device may be an infusion pump adapted to deliver fluids (e.g., including nutrients or medications) into a patient's body in controlled amounts.

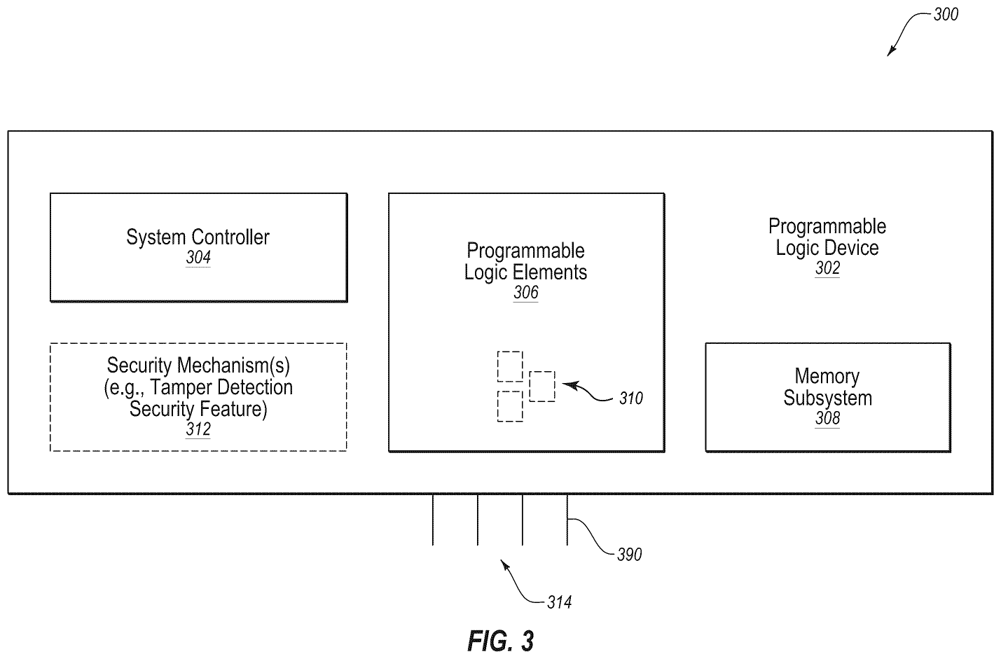

FIG. 3 is a schematic block diagram of an apparatus 300 comprising a programmable logic device 302 including a safety verification mechanism, according to one or more examples of the disclosure. In one or more examples, programmable logic device 302 is an FPGA, and more particularly, a flash FPGA. In FIG. 3, programmable logic device 302 includes a system controller 304, programmable logic elements 306, a memory subsystem 308, and input/output (I/O) lines 314.

Programmable logic elements 306 are configurable to implement functions (e.g., logic functions) according to configuration data. Programmable logic elements 306 include a number of logic blocks 310. Logic blocks 310 include fundamental building blocks configurable to perform various logic functions. For example, logic blocks 310 may include or provide customizable logic gates to be arranged and interconnected to create (e.g., custom and/or more complex) digital circuits within programmable logic device 302. The interconnected logic blocks of programmable logic elements 306 may be referred to as the FPGA fabric of programmable logic device 302.

Logic blocks 310 may include intellectual property (IP) blocks, configurable logic blocks (CLBs), and input/output blocks (IOBs), as a few examples. An IP block is a pre-designed, reusable block of logic with a specific functionality (e.g., a memory controller, or a communication protocol). A configurable logic block is a small circuit configurable as a custom logic circuit to perform a custom logic function. An input/output block is a dedicated circuit (e.g., located on the periphery of the chip) serving as an interface between the internal configured logic and external pins (e.g., input and output lines 314) of the device.

Programmable logic elements 306 also include internal memory elements to store the configuration data that configures programmable logic elements 306 (e.g., logic blocks 310) to implement the functions. The internal memory elements may be or include non-volatile or flash memory cells (e.g., FIG. 1).

Memory subsystem 308 provides a dedicated memory area to store data that can be readily accessed by the FPGA logic. Memory subsystem 308 includes memory, such as non-volatile memory, which may be referred to as embedded non-volatile memory (eNVM), and volatile memory, which may be SRAM. Memory subsystem 308 may also include one or more memory controllers, one or more bus interfaces, one or more communication interfaces, and so on.

System controller 304 is to manage configuration, initialization, and programming of programmable logic device 302. For example, system controller 304 is to serve as a central hub to control functionality of programmable logic device 302, setting up logic circuits (e.g., logic blocks 310) and managing data flow in the chip, as well as allowing for flexible reconfiguration according to needs of the application(s).

System controller 304 is also to manage and control security mechanisms 312 of programmable logic device 302. Security mechanisms 312 include security mechanisms to detect and/or protect against configuration tampering of programmable logic device 302. In one or more examples, one of security mechanisms 312 is a tamper detection security mechanism or function to detect unauthorized modifications to the configuration data. In one or more examples, the tamper detection security function uses a digest value, a unique cryptographic hash computed from the configuration data. The digest value is stored in memory (e.g., eNVM) of memory subsystem 308 and subsequently used to verify if the configuration of programmable logic elements 306 has been tampered with. If the computed digest value does not match the stored digest value, the tamper detection security function flags or signals a tampering indication.

Given the above-described arrangement, programmable logic device 302 may be programmed and reprogrammed “on-the-fly” by loading new configuration data into the non-volatile memory cells. Reprogramming with new configuration data changes the functionality of programmable logic device 302 without physically altering circuitry thereof. The configuration of the logic (and/or other advanced functions) persists even when power is removed or lost. In contrast, in SRAM-based programmable logic devices, configuration data is loaded into internal SRAM memory cells of the programmable logic elements (e.g., every time) when power is applied (as the SRAM is volatile memory). The configuration data stored in the internal SRAM cells of the programmable logic elements define the device's logic during operation.

As discussed earlier, programmable logic device 302 includes a safety verification mechanism. In one or more examples, the safety verification mechanism is distributed within programmable logic device 302. At least some operations, features, or portions of the safety verification mechanism of programmable logic device 302 are provided in logic blocks 310 (e.g., including IP blocks, CLBs, and/or IOBs) of programmable logic elements 306. Additional operations, features, or portions of the safety verification mechanism of programmable logic device 302 may be provided in system controller 304 and security mechanisms 312.

An overview of the safety verification mechanism is provided. In response to a programming (e.g., an initial programming) of the configuration data in the non-volatile memory cells, a digest value is computed based on the configuration data. The digest value is stored in memory (e.g., the eNVM of memory subsystem 308). For safety verification, it is desirable to check (e.g., regularly or occasionally) the configuration data stored in the non-volatile memory cells of programmable logic elements 306, as programmable logic elements 306 (e.g., logic blocks 310) are configurable to implement functions according to the configuration data.

During use of the device, in response to power-up or other trigger, programmable logic element 306 is to perform an integrity check to verify whether a currently computed digest value matches the digest value stored in the memory. In one or more examples, the integrity check is a (e.g., built-in, internal) security feature of programmable logic device 302 (e.g., the tamper detection security feature of security mechanisms 312). In the integrity check, the currently computed digest value is computed at least partially based on current configuration data stored in the non-volatile memory cells of programmable logic elements (e.g., involving a scan of the FPGA fabric and corresponding computations).

In response to a verification of a match between the currently computed digest value and the digest value in the integrity check, programmable logic device 302 proceeds to perform further actions for an external validation. In one or more examples, the further actions may be performed by (at least part of) the same logic that was verified in the integrity check.

More particularly, programmable logic device 302 proceeds to read or obtain the digest value, determine a check value at least partially based on the digest value, and provide the check value at an output for external verification (e.g., at a verification circuit). In response to a failure in the verification in the integrity check, programmable logic device 302 refrains from performing the actions for external validation (i.e., refrains from performing the reading, the determining, and/or providing). In one or more examples, the digest value is a SHA value (e.g., SHA-256 value) computed based on a SHA cryptographic hash algorithm of the configuration data, and the check value is a CRC value (e.g., CRC-16 value) computed based on a CRC function.

In one or more other examples, the safety verification mechanism is performed in relation to at least two (2) digest values (e.g., two (2) SHA-256 values): a first digest value associated with the non-volatile memory cells of programmable logic elements 306, and a second digest value associated with user configuration data stored in other non-volatile memory (e.g., stored in memory subsystem 308). Here, a single check value (e.g., a single CRC-16 value) for verification may be calculated based on the two (2) digest values.

Thus, the logic verified in the integrity check is used to access the digest value (e.g., SHA-256 value) from the memory of programmable logic device 302, and then the digest value is converted into the check value (e.g., CRC-16 value). The check value may be communicated to a verification circuit, external from programmable logic device 302, for comparison to a prestored check value (e.g., prestored CRC-16 value). If a match between the calculated check value and the prestored check value is detected, the verification circuit is to output an enable signal to enable operation or for activation.

In FIG. 3, programmable logic device 302 of FIG. 3 has been described as a flash FPGA. In one or more other examples, programmable logic device 302 is a programmable SoC including a microcontroller or a microprocessor. The programmable SoC may further include additional processor cores including peripherals, such as a graphics processing unit (GPU), a Wi-Fi network radio modem, a cellular network radio modem, and so on. In one or more alternative examples, where programmable logic device 302 of FIG. 3 is a programmable SoC, memory subsystem 308 of FIG. 3 is replaced with a microcontroller subsystem including the microcontroller, the microprocessor, and/or the additional processor cores including the peripherals.

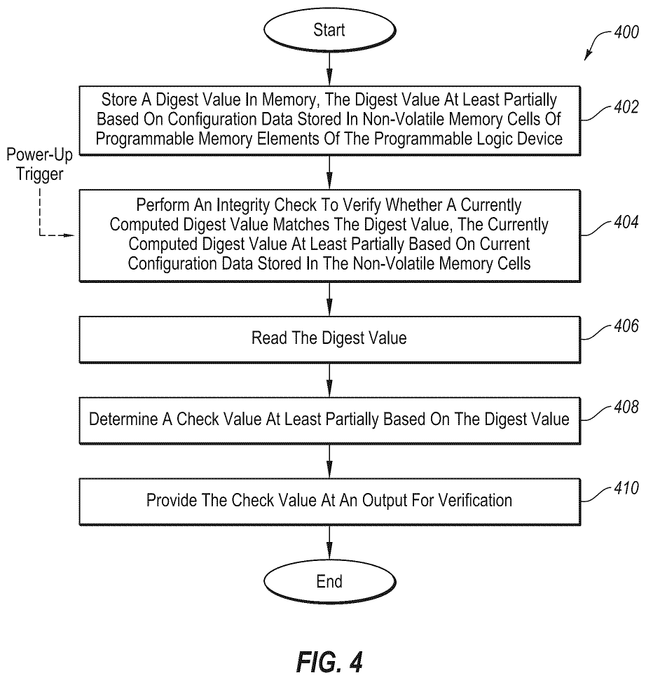

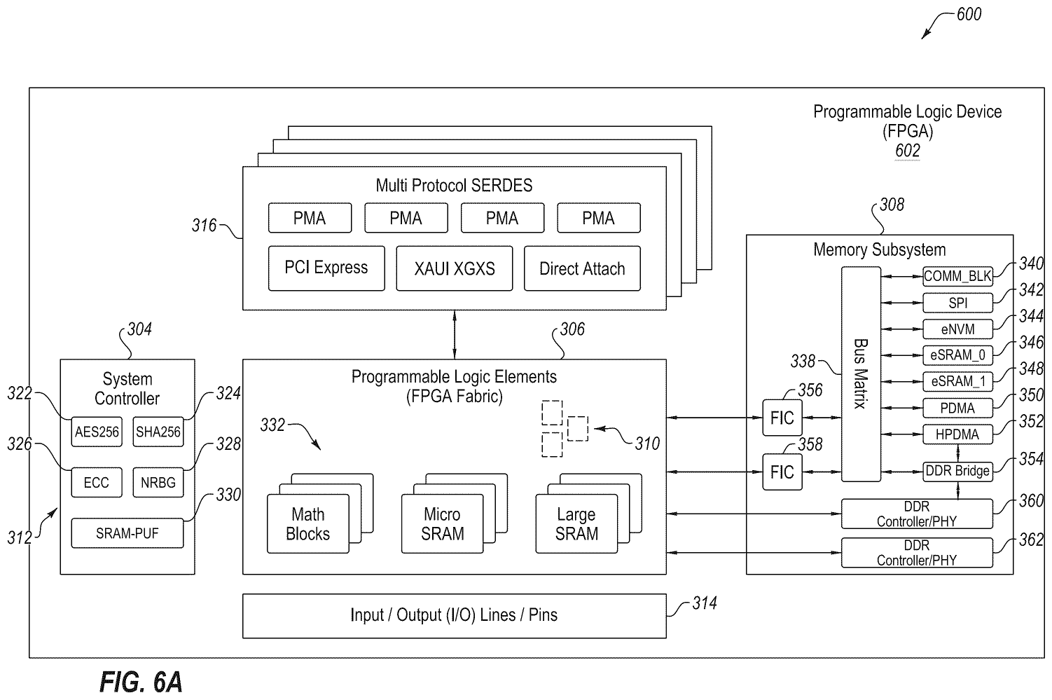

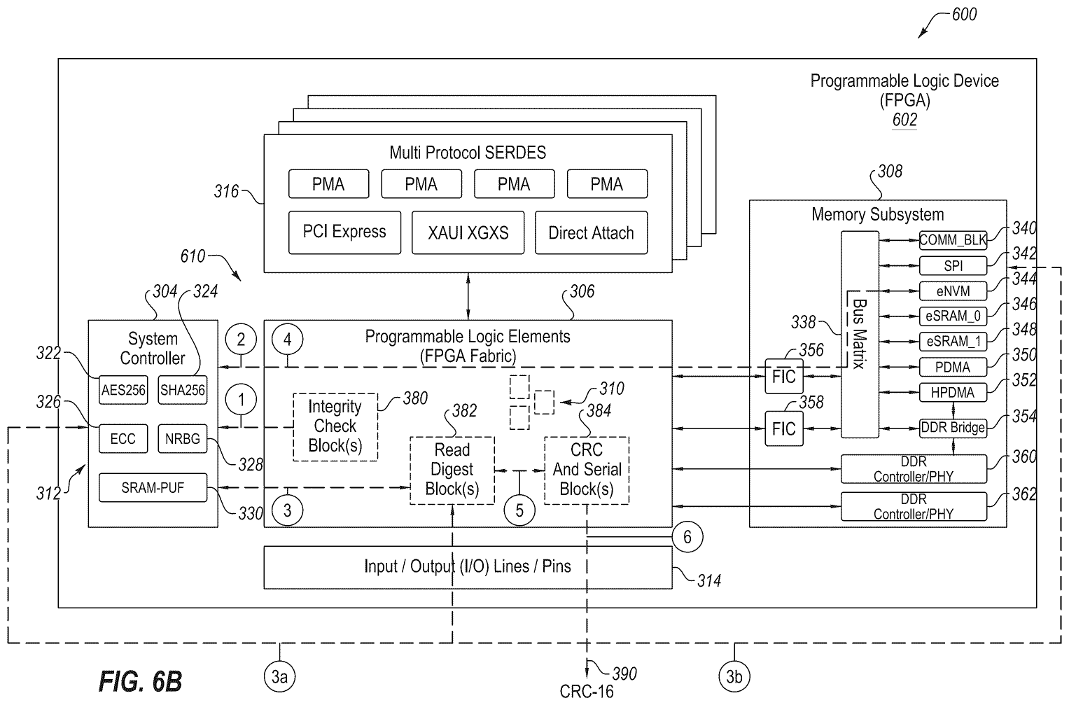

FIG. 4 is a flowchart of a method 400 of safety verification for a programmable logic device, according to one or more examples. In one or more examples, method 400 may be performed at a programmable logic device including programmable logic elements. The programmable logic elements are configurable to implement functions according to configuration data stored in non-volatile memory cells of the programmable logic elements. In one or more examples, method 400 is performed at a programmable logic device configured according to one or more examples of the disclosure (e.g., according to programmable logic device 302 of FIG. 3, or a programmable logic device 602 of FIG. 6A or FIG. 6B described below).

In FIG. 4, method 400 includes, at an act 402, storing a digest value in memory of the programmable logic device. The digest value is at least partially based on the configuration data stored in the non-volatile memory cells of the programmable logic elements. Method 400 includes, at an act 404, performing an integrity check to verify whether a currently computed digest value matches the digest value. The currently computed digest value is at least partially based on current configuration data stored in the non-volatile memory cells of the programmable logic elements. Method 400 includes, at an act 406, reading the digest value. Method 400 includes, at an act 408, determining a check value at least partially based on the digest value. Method 400 includes, at an act 410, providing the check value at an output of the programmable logic device.

In one or more examples, the reading at act 406, the determining at act 408, and the providing at act 410 are performed at least partially responsive to a verification of a match between the currently computed digest value and the digest value in act 402 (i.e., the integrity check). On the other hand, the reading at act 406, the determining at act 408, and the providing at act 410 (or alternatively, e.g., at least the providing at act 410) are refrained from being performed at least partially responsive to a failure in the verification in act 402.

In one or more examples, the digest value stored in the memory is previously computed and stored by the programmable logic device at least partially responsive to a programming of the configuration data in the non-volatile memory cells of the programmable logic elements. In one or more examples, performing the integrity check at act 402 includes computing the currently computed digest value at least partially based on the current configuration data stored in the non-volatile memory cells of the programmable logic elements. In one or more specific examples, computing the current computed digest value comprises computing a SHA-256 value at least partially based on a SHA-256 cryptographic hash function on the current configuration data stored in the non-volatile memory cells of the programmable logic elements.

In one or more examples, determining the check value at act 408 comprises calculating a CRC value from the digest value. Here, in one or more examples, the check value may be or include the CRC value (e.g., a CRC-16 value). In one or more examples, determining the check value comprises selecting one or more prespecified portions of the digest value. Here, in one or more examples, the check value comprises the selected one or more prespecified portions of the digest value (e.g., if using multiple portions, the portions may be appended to one another). In a specific, non-limiting example, the selected one or more prespecified portions of the digest value may be a prespecified truncated portion of the digest value.

In one or more other examples, method 400 is performed in relation to at least two (2) digest values (e.g., two (2) SHA-256 values): a first digest value associated with the non-volatile memory cells of the programmable logic elements, and a second digest value associated with user configuration data stored other non-volatile memory. Here, a single check value (e.g., a single CRC-16 value) for verification may be calculated based on the two (2) digest values.

In one or more examples, method 400 includes initiating the performing at act 404, the reading at act 406, the determining at act 408, and the providing at act 410 at least partially responsive to a power-up of the programmable logic device or a system including the programmable logic device. In one or more examples, method 400 includes initiating the performing at act 404, the reading at act 406, the determining at act 408, and the providing at act 410 at least partially responsive to respective timeouts of a periodic timer of the programmable logic device. In one or more examples, method 400 includes initiating the performing at act 404, the reading at act 406, the determining at act 408, and the providing at act 410 at least partially responsive to a signal received at an external pin of the programmable logic device, and/or an instruction of a communication received at a port of the programmable logic device.

In one or more examples, providing the check value at the output at act 410 comprises (e.g., serially) outputting the check value at the output for verification (e.g., at a verification circuit external from and operably coupled to the programmable logic device). In one or more examples, the programmable logic device is configurable to implement the functions according to the configuration data stored in the non-volatile memory cells to operate or operate with an electronic circuitry or component(s) of a system. Method 400 further includes providing the check value at the output for verification, operating or operating with the electronic circuitry or component of the system (e.g., engage in normal system operation) at least partially responsive to receiving an enable signal, and refraining from operating or operating with the electronic circuitry or component of the system (e.g., refrain from engaging in normal system operation) at least partially responsive to not receiving the enable signal. The enable signal indicates verification of a match between the check value and a stored check value (e.g., indicating that the current configuration data matches the initial or previous configuration data).

In one or more examples, the programmable logic device includes a system controller, an I/O interface (e.g., associated with I/O lines 314 of FIG. 3) including an I/O interface controller, and a communication interface including a communication interface controller. The communication interface controller is operably coupled to the system controller, and the I/O interface coupled to the communication interface. In one or more examples of method 400, reading the digest value at act 406 comprises sending a command, via the I/O interface and the communication interface coupled to the I/O interface, to the system controller, the command indicating to read data from the memory; receiving the data in response to sending the command; and obtaining the digest value from the received data. In one or more examples, the I/O interface and/or communication interface is one of a Joint Test Action Group (JTAG) interface or a Serial Peripheral Interface (SPI).

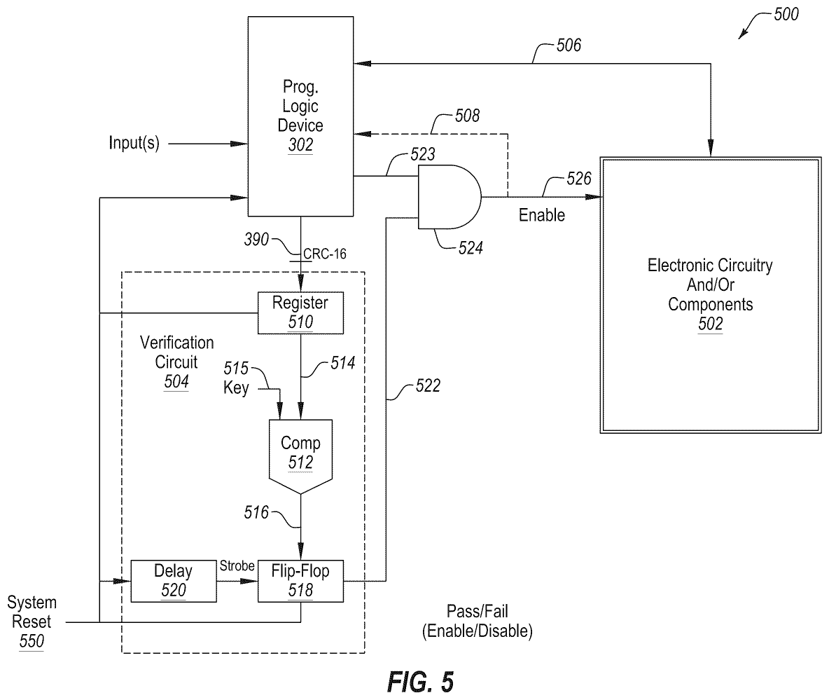

FIG. 5 is a system 500 including programmable logic device 302 having a safety verification mechanism, according to one or more examples. System 500 of FIG. 5 may be associated with an application, such as a safety-critical application, having a general need or requirement for safety verification of programmable logic device 302. In one or more examples, programmable logic device 302 of system 500 is configured according to one or more examples of the disclosure (e.g., according to programmable logic device 302 of FIG. 3, method 400 of FIG. 4, and/or programmable logic device 602 of FIG. 6A or FIG. 6B).

System 500 includes programmable logic device 302 to operate or operate with an electronic circuitry and/or component(s) (“electronic circuitry 502”) of system 500 (e.g., via control and/or signal lines 506). More particularly, programmable logic device 302 includes programmable logic elements configurable to implement functions according to configuration data stored in non-volatile memory cells to operate or operate with electronic circuitry 502 of system 500. Programmable logic device 302 also includes memory (e.g., eNVM) to store a digest value (e.g., SHA-256 value), which has been (e.g., previously) computed at least partially based on the configuration data stored in the non-volatile memory cells.

In one or more examples, system 500 is part of a safety-critical device or equipment. As one example, system 500 may be part of a fuze for a munitions device or equipment. Here, programmable logic device 302 and verification circuit 504 are configured to be in compliance with the JOTP-051 Technical Manual (see, e.g., Appendix A on page 6). As another example, system 500 may be part of a medical device or equipment. In a specific, non-limiting example, system 500 may be part of a medical device or equipment that is or includes an infusion pump. The infusion pump operates to deliver a fluid (e.g., including medications or nutrients) in controlled amounts into a patient's body.

In response to a power-up of system 500 (e.g., and/or a corresponding power-up of programmable logic device 302 (e.g., via a system reset signal at a reset input 550)), programmable logic device 302 is to perform an integrity check to verify whether a currently computed digest value matches the digest value. If the digest value is positively verified (e.g., verification of the match), programmable logic device 302 is to read the digest value, determine a check value (e.g., CRC-16 value) at least partially based on the digest value, and provide the check value at an output 390 of programmable logic device 302. If the digest value is not positively verified (e.g., failure of the verification or no match), programmable logic device 302 is to refrain from performing the reading, determining, and providing.

In one or more examples, programmable logic device 302 is to determine the check value at least partially based on calculating a CRC value (e.g., CRC-16 value) from the digest value. Here, the check value is or includes the CRC value. In one or more other examples, programmable logic device 302 is to determine the check value at least partially based on selecting one or more prespecified portions of the digest value. Here, the check value is or includes the one or more selected prespecified portions of the digest value (e.g., if using multiple portions, the portions may be appended to one another). In a specific, non-limiting example, the selected one or more prespecified portions of the digest value may be a prespecified truncated portion of the digest value.

A verification circuit 504 is operably coupled to programmable logic device 302. In one or more examples, verification circuit 504 includes a register 510 and a comparator 512. Register 510 has an input coupled to output 390 of programmable logic device 302 and an output coupled to an input 514 of comparator 512. Register 510 is to receive and store the check value (e.g., the CRC-16 value) from output 390 of programmable logic device 302, and provide the check value to input 514 of comparator 512. Comparator 512 is to compare the check value at input 514 and a stored check value (“key”) received at an input 515. Comparator 512 is to provide an enable signal at an output 516 at least partially responsive to a match between the check value and the stored check value. Comparator 512 refrains from providing the enable signal (e.g., maintains a disable signal) at output 516 when there is no match between the check value and the stored check value. At least eventually, the enable signal is to enable operation of at least one of programmable logic device 302 and electronic circuitry 502.

In one or more examples, verification circuit 504 further includes a flip flop 518 and a delay 520, each of which is coupled to reset input 550. Flip flop 518 is triggered to latch the signal (e.g., enable/disable) from output 516 of comparator 512 at least partially responsive to the system reset signal and/or a delayed system reset signal from an output of delay 520. Thus, the signal (e.g., enable/disable) from output 516 of comparator 512 may be provided at an output 522 of flip flop 518 (indicated in FIG. 5 as “Pass/Fail” and “Enable/Disable”). In one or more examples, verification circuit 504 further includes a logic gate 524 (e.g., an AND gate) that is at least partially responsive to (e.g., both) the signal at output 522 and a signal (e.g., an enable/disable signal) from an output 523 of programmable logic device 302. If both signals indicate “enable” (e.g., per AND logic), logic gate 524 is to provide an enable signal at an output 526 coupled to electronic circuitry 502 to enable its operation. Output 526 may also be coupled to an input of programmable logic device 302 to enable operation of programmable logic device 302 at least partially responsive to the enable signal.

Thus, in one or more examples, programmable logic device 302 is to output the check value at output 390 for verification at verification circuit 504. Verification circuit 504 is to compare the check value and a stored check value, and provide an enable signal at an output (e.g., output 516, output 522, and/or output 526) at least partially responsive to a match between the check value and the stored check value. The enable signal is to enable operation of at least one of programmable logic device 302 and electronic circuitry 502 (e.g., engage in normal system operation).

As discussed above, programmable logic device 302 is to initiate the acts to perform, to read, to determine, and to provide at least partially responsive to power-up of system 500 and/or programmable logic device 302. In one or more examples, programmable logic device 302 is to further initiate the acts to perform, to read, to determine, and to provide at least partially responsive to respective timeouts of a periodic timer of programmable logic device 302. In one or more examples, programmable logic device 302 is to further initiate the acts to perform, to read, to determine, and to provide at least partially responsive to a signal received at an external pin of programmable logic device 302, and/or an instruction of a communication received at a port of programmable logic device 302.

FIG. 6A is a schematic diagram of an apparatus 600 comprising a programmable logic device 602 (e.g., a flash FPGA) including a safety verification mechanism, according to one or more examples. In one or more examples, programmable logic device 602 of FIG. 6A is more specific implementation of programmable logic device 302 of FIG. 3. Accordingly, programmable logic device 602 includes system controller 304, programmable logic elements 306, memory subsystem 308, and input and output lines 314, as previously discussed in relation to programmable logic device 302 of FIG. 3.

As previously discussed, programmable logic device 602 of FIG. 6A includes programmable logic elements 306 (e.g., logic blocks 310 within the FPGA fabric) configurable to implement functions according to configuration data. The configuration data is stored in non-volatile memory cells of the FPGA fabric. The configuration data persists in this non-volatile memory even when power of the flash FPGA is removed or lost. The FPGA fabric may also include one or more additional blocks, such as math blocks, micro SRAM, and large SRAM, as indicated in the figure.

More specifically, math blocks are optimized for DSP applications such as Finite Impulse Response (FIR) filters, Infinite Impulse Response (IIR) filters, Fast Fourier Transform (FFT) functions, and encoders that require high data throughput. SRAM blocks can be used to store user data directly within the FPGA logic itself, allowing for fast access to large amounts of data in the design. Micro SRAM refers to a small, dedicated block of SRAM embedded within the FPGA fabric, typically offering a smaller capacity compared to large SRAM but with potentially more flexible access ports and configuration options. Large SRAM (or Block RAM units) is significantly larger than standard logic cells within the FPGA fabric, allowing for storing larger amounts of data, and for applications requiring high-speed data access and processing within the FPGA logic.

I/O lines 314 may be multi-standard General Purpose I/O (GPIO), adapted to operate within a voltage range between 1.2 volts and 3.3 volts, thereby allowing it to interface with various external devices having different voltage levels. I/O lines 314 may include I/O for Low Voltage Differential Signaling (LVDS), a differential signaling system that uses two wires to communicate data. I/O lines 314 may also include I/O for High-Speed Transceiver Logic (HSTL) and Stub Series-Terminated Logic (SSTL), signaling standards used for high-speed memory subsystems.

In FIG. 6A, programmable logic device 602 also includes a serial/deserializer (SERDES) block 316 for communication. In one or more examples, SERDES block 316 is a multi-protocol SERDES configured to support multiple different communication protocols (e.g., Peripheral Component Interconnect Express (PCIe), Ethernet, or Serial Advanced Technology Attachment (SATA), and so on). The support of the multiple protocols may be on a single set of physical lanes, allowing the FPGA to interface with various devices using a single high-speed serial link instead of requiring dedicated lanes for each protocol. By supporting multiple protocols, SERDES block 316 can be used for diverse communication needs within a single FPGA design, reducing complexity and chip area.

In addition to using Direct Attach, SERDES block 316 may utilize 10 Gigabit Attachment Unit Interface (XAUI), a standard that extends 10 Gigabit Media Independent Interface (XGMII) in 10 Gigabit Ethernet (10 GbE) systems, and 10 Gigabit Ethernet Extended Sublayer (XGXS), which is a bridging function that connects XGMII and XAUI devices.

The multi-protocol functionality of SERDES block 316 is facilitated by one or more Physical Coding Sublayer (PCS) modules configured to adapt the data stream to the specific requirements of each protocol (e.g., encoding schemes and signaling levels). One or more Physical Media Attachment (PMA) modules are configured to handle analog signal transmission, designed to support different electrical characteristics of the various protocols.

In example operation, FPGA logic may send data to SERDES block 316 in parallel format, indicating the selected protocol. A PCS module within SERDES block 316 performs the necessary encoding and formatting based on the selected protocol. The data is then serialized into a single high-speed bitstream by a PMA module. The serialized data may then be transmitted on the physical lanes.

As discussed previously, memory subsystem 308 of FIG. 6A provides a dedicated memory area to store data that can be readily accessed by the FPGA logic. Memory subsystem 308 includes memory, such as an eNVM 344, as well as embedded SRAM (eSRAM) including an eSRAM_0 346 and an eSRAM_1 348. A peripheral direct memory access (PDMA) controller 350 may be provided to transfer data between a peripheral and memory. A high-performance direct memory access (HPDMA) controller 352 may be provided for high-speed data transfers between memory and peripherals, or between memories. Memory subsystem 308 also includes a double data rate (DDR) bridge 354 coupled to a DDR controller/PHY 360; a DDR controller/PHY 362 is also provided. A communication block (COMM_BLK) 340 may include, in some examples, an advanced peripheral bus (APB) interface, a transmit first-in first-out (FIFO) (e.g., an 8-byte transmit FIFO) and a receive FIFO (e.g., an 8-byte receive FIFO) for communication. A bus matrix 338, which may be an Advanced High-performance Bus (AHB) bus matrix, is connected to the above-described components, including COMM_BLK 340, SPI 242, eNVM 344, eSRAM_0 346, eSRAM_1 348, PDMA 350, and HPDMA 352, and DDR bridge 354. Bus matrix 338 is also connected to the FPGA fabric via fabric interface controllers (FICs) 356 and 358. DDR controller/PHY 360 and DDR controller/PHY 362 are also connected to bus matrix 338.

Security mechanisms 312 of system controller 304 may generally be classified as either design security mechanisms or data security mechanisms. Design security mechanisms protect the actual design associated with the system. Design security mechanisms also protect the intent of the owner of the design, typically by keeping the design and associated bitstream keys confidential, preventing design changes, and controlling the number of copies made throughout the device life cycle. Such mechanisms may also apply to the device from its initial production, including any updates, such as in-the-field upgrades. They also protect against tampering, cloning, overbuilding, reverse engineering, and/or counterfeiting. In one or more examples, design security mechanisms include encrypted key and bitstream loading (using an AES-256 module 322) to allow configuration to be performed in less trusted locations. In addition, the design security mechanisms may include secure programming with a SHA-256 module 324 for bitstream authentication. Further, the design security mechanisms include an Elliptic Curve Cryptography (ECC) module 326 for securely loading user keys. Also, the design security mechanisms may include an SRAM-based Physically Unclonable Function (SRAM-PUF) module 330 for key generation and device authentication.

Data security mechanisms protect the data associated with the applications running on the system. Data security mechanisms protect the information a device is storing, processing, or communicating in its role in the application. In addition, data security mechanisms include user cryptographic services, through use of, for example, AES-256 module 322, SHA-256 module 324, and/or a hash-based message authentication code (HMAC) module. Furthermore, data security mechanisms may include a Non-Deterministic Random Bit Generation (NRBG) module 328 for secret keys and nonces. Further, data security mechanisms include advanced key storage and management based on a PUF (e.g., a feature analogous to a biometric). Even further, data security mechanisms may include hardware firewalls to protect sensitive data from unauthorized access.

FIG. 6B is a schematic diagram of apparatus 600 including programmable logic device 602 of FIG. 6A, including the addition of logic blocks associated with the safety verification mechanism, according to one or more examples. FIG. 6B also indicates a process flow 610 of processing for safety verification using the logic blocks associated with the safety verification mechanism, according to one or more examples.

Logic blocks associated with the safety verification mechanism include one or more integrity check blocks (an “integrity check block 380”), one or more read digest blocks (a “read digest block 382”), and one or more CRC and serial blocks (a “CRC and serial block 384”). Read digest block 382 and CRC and serial block 384 may include one or more IP blocks/RTL, pre-designed, reusable circuit blocks written in Register Transfer Level (RTL) code, and/or any other type of logic block (e.g., IP, CLB, or IOB).

Integrity check block 380 is to initiate (and/or control, manage, and/or perform at least part of) an integrity check, which verifies whether a currently computed digest value(s) of the FPGA matches the digest value(s) stored in eNVM 344. In one or more examples, processing associated with integrity check block 380 (e.g., initiating the integrity check) may be initiated or triggered in response to a power-up of programmable logic device 602. Read digest block 382 controls and/or manages the reading of the digest value(s) (e.g., SHA-256 value(s)) from eNVM 344 and/or the storing of the read digest value(s) in registers. Processing associated with read digest block 382 may be initiated or triggered in response to receiving a positive verification from the integrity check. CRC and serial block 384 computes a CRC value (e.g., a CRC-16 value) based on the retrieved digest value(s), stored in the registers by read digest block 382, and serially outputs the CRC value at output 390 for verification. In one or more examples, there are two (2) digest values to verify and read: a first digest value associated with the FPGA fabric and a second digest value associated with user data stored in eNVM 344; here, a single CRC value (e.g., a single CRC-16 value) is calculated based on the two (2) digest values.

In an act 1 of process flow 610, integrity check block 380 is to initiate and/or perform an integrity check, which verifies whether a currently computed digest value(s) matches the digest value(s) stored in eNVM 344. In one or more examples, the integrity check is built into the FPGA architecture with a built-in macro, called “Tamper,” provided for security applications. Use of this macro allows for determining whether the FPGA logic and eNVM 344 is correctly programmed with the user's logic and data. More particularly, the digest value(s) is checked by system controller 304, which accesses the digest value(s) at an act 2 of process flow, scans the FPGA (e.g., the FPGA fabric), calculates the new (currently computed) digest value(s), and compares the scan result with the digest value(s). Upon completion, the “Tamper” macro provides a signal of whether the integrity check has succeeded or failed.

In an act 3 of process flow 610, read digest block 382 is to perform a read of the digest value(s) from eNVM 344 through system controller 304. Processing associated with read digest block 382 is initiated or triggered in response to receiving the signal that the integrity check succeeded. In one or more examples, the read of the digest value(s) may be at a set location in eNVM 344. In an act 4 of process flow 610, system controller 304 is to retrieve the digest value(s) from eNVM 344 and pass to read digest block 382 (e.g., in registers, memory controller, or local memory). In one or more examples, the read of the digest value(s) in acts 3 and 4 of process flow 610 involves an internal read, which is (e.g., entirely) internal to programmable logic device 602.

In one or more examples, the read of the data from eNVM 344 in acts 3 and 4 includes data other than the digest value(s), and read digest block 382 is to parse the data to identify and obtain the digest value(s) (e.g., more generally, read digest block 382 is to identify and select the digest value from the data). In one or more other examples, a digest service request for requesting the digest value(s) is utilized to obtain the digest values(s), and parsing data is unnecessary.

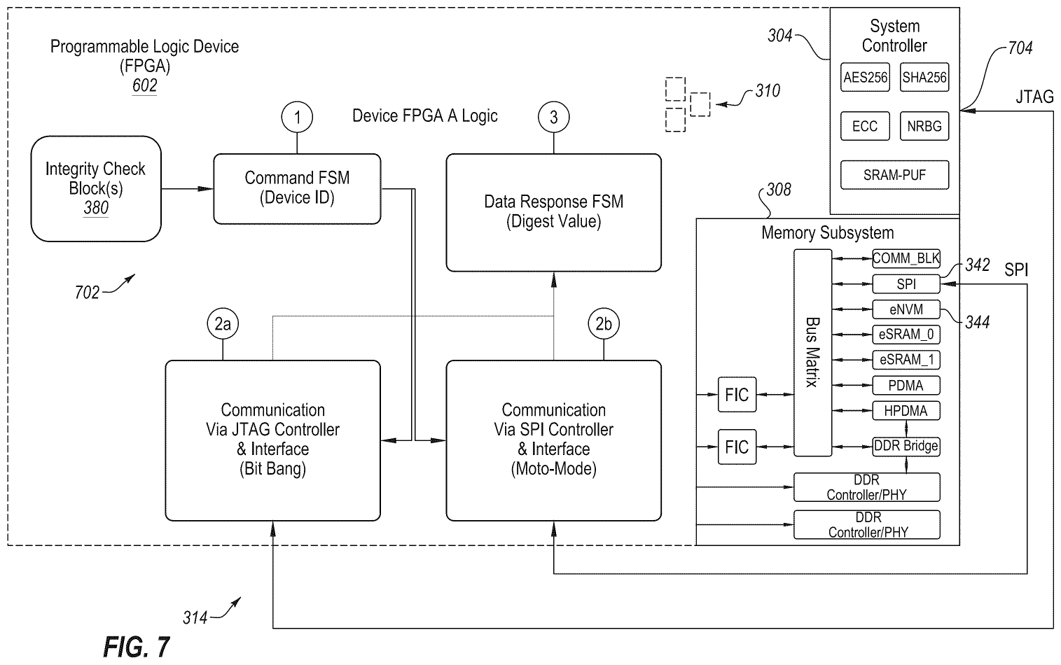

In one or more other examples, the read of the digest value(s) is alternatively performed in an act 3a or an act 3b of process flow 610 as an external read, which is at least partially externally to programmable logic device 602. In one or more examples, the external read is performed via a communication interface, such as a JTAG communication interface (in act 3a) (via system controller 304) or an SPI communication interface (e.g., SPI 342) (in act 3b). The external read of the digest value(s) may be provided for programmable logic devices that do not make available internal reads of the digest value(s). The external read of the digest value(s) is described in more detail in relation to FIG. 7.

In an act 5 of process flow 610, CRC and serial block 384 is to perform a CRC on the digest value(s) (e.g., the SHA-256 digest values) read by read digest block 382, to generate a CRC value (e.g., a CRC-16 value). For example, a single CRC value (e.g., a single CRC-16 value) may be calculated based on the two (2) digest values. CRC and serial block 384 is to communicate or transfer (e.g., a parallel to serial transfer) the CRC value at output 390 to a verification circuit for verification.

Programmable logic device 602 of FIGS. 6A and 6B has been described as a flash FPGA. In one or more other examples, programmable logic device 602 is a programmable SoC including a microcontroller or a microprocessor. The programmable SoC may further include additional processor cores including peripherals, such as a GPU, a Wi-Fi network radio modem, a cellular network radio modem, and so on. In one or more other examples, where programmable logic device 602 of FIGS. 6A and 6B is a programmable SoC, memory subsystem 308 of FIGS. 6A and 6B is replaced with a microcontroller subsystem including the microcontroller, the microprocessor, and/or the additional processor cores including the peripherals.

FIG. 7 is a process flow diagram of a process flow 702 for reading a digest value stored in programmable logic device 602, according to one or more examples. The read of the digest value(s) described in process flow 702 of FIG. 7 is associated with the external read as indicated in act 3a or act 3b of process flow 610 of FIG. 6B.

The external read associated with process flow 702 may be initiated or triggered in response to receiving a positive verification from the integrity check associated with integrity check block 380 (e.g., the “Tamper” macro provides a signal of whether the integrity check has succeeded or failed). In an act 1 of process flow 702, the FPGA logic is to initiate a DEVICE ID command (e.g., “Command FSM (Device ID)”) to system controller 304 through a communication interface. The communication interface will be an application-required interface, one of either a JTAG communication interface 704 (the connection for JTAG being on the part itself) or an SPI communication interface (e.g., SPI 342). In an act 2a of process flow 702, the JTAG interface controller is to format the DEVICE ID command to system controller 304. Alternatively, in an act 2b of process flow 702, the SPI interface controller is to format the DEVICE ID command to system controller 304. System controller 304 is to retrieve data including the digest value(s) from eNVM 344 and communicate a response having the data through the application-required interface. In an act 3 of process flow 702, the FPGA logic receives the response having the data including the digest value(s) (e.g., “Data Response FSM (Digest Value)”). The response is filtered for information associated with the digest value(s) and stored in registers for further computation.

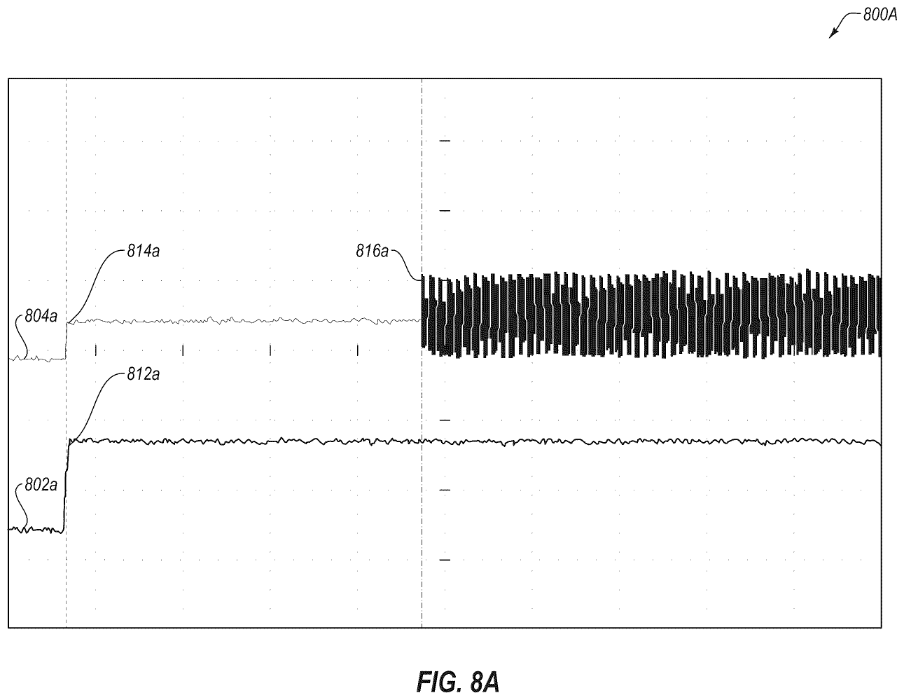

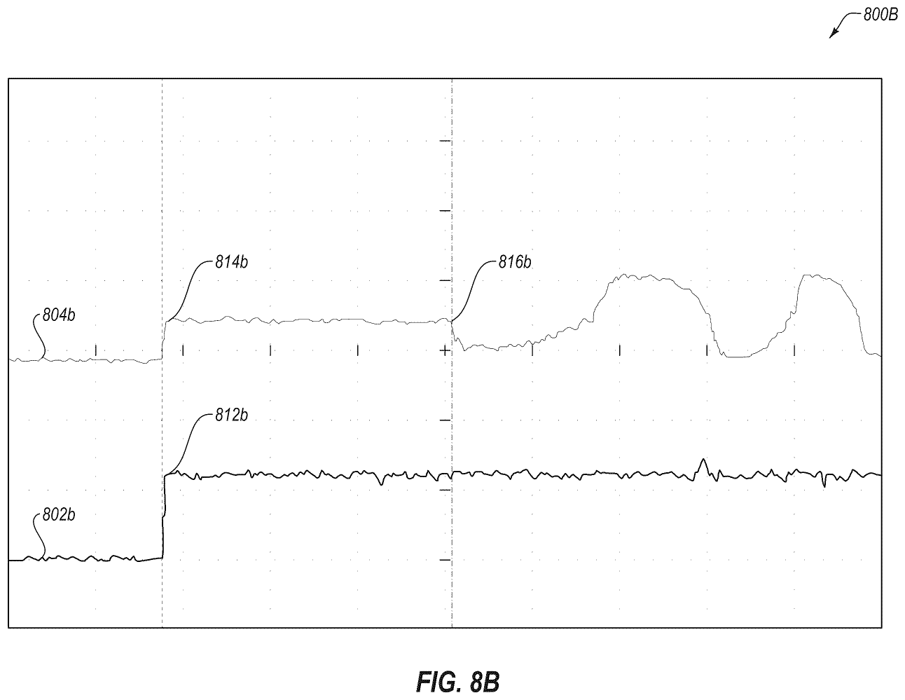

FIG. 8A is a graph 800A of measured operating signals of a programmable logic device configured without safety verification. FIG. 8B is a graph 800B of measured operating signals of a programmable logic device configured with safety verification according to one or more examples. In general, FIGS. 8A and 8B can be used for a basic assessment and comparison of actual start times of operation of a programmable logic device without safety verification (FIG. 8A) and with safety verification (FIG. 8B) (e.g., as safety verification is performed in response to power-up of the programmable logic device associated with FIG. 8B).

In FIG. 8A, the measured operating signals in graph 800A include a power-up signal 802a (the bottom signal) and a clock signal 804a (the top signal). A rising-edge point 812a on power-up signal 802a identifies a rising edge that indicates the time of power-up of the programmable logic device. A corresponding rising-edge point 814a on clock signal 804a corresponding to the time of power-up is also indicated. A clock signal activity point 816a on clock signal 804a identifies clock signal activity that indicates (at least a start of) active operation of the programmable logic device. In one or more examples, the time delay between the time of power-up and the time active operation of the programmable device without the safety verification is about 3.2 milliseconds (msec).

In FIG. 8B, like graph 800A of FIG. 8A, the measured operating signals include a power-up signal 802b (the bottom signal) and a clock signal 804b (the top signal). Note that, due to the slightly increased time to power-up of the device, the time reference is slightly expanded in FIG. 8B relative to the time reference in FIG. 8A. A rising-edge point 812b on power-up signal 802b identifies a rising edge, which indicates the time of power-up of the programmable logic device, which is also indicated at a corresponding rising-edge point 814b on clock signal 804b. A clock signal activity point 816b on clock signal 804b identifies clock signal activity that indicates (at least a start of) active operation of the programmable logic device (i.e., actual active operation after safety verification).

In one or more examples, the time delay between the time of power-up and the time of active operation of the programmable logic device with safety verification (FIG. 8B) is about 500 msec (e.g., not an unreasonable delay for many applications). In one or more other examples, the time delay between the time of power-up and the time of active operation of another tested programmable logic device with safety verification (FIG. 8B) is about 888 msec. It has been observed that the time delay for active operation of a programmable logic device including safety verification increases according to the size/density of the device.

One or more advantages may be realized according to one or more examples of the disclosure. In one or more examples, the safety verification mechanism is provided as a single-chip solution with integrity checking and reporting. In one or more examples, the safety verification mechanism is workable and can be performed with extended operation if and as needed. The safety verification mechanism is adapted to keep a user's configuration solution secure while eliminating doubt regarding any uncertain operation.

In one or more alternative examples of the disclosure, the safety verification mechanism is to operate in the same or similar manner as described above (e.g., in relation to FIGS. 3, 4, 5, 6A, 6B, and 7), but where the configuration data for the FPGA fabric is stored in (e.g., on-chip) non-volatile memory separate from the FPGA fabric (e.g., in a memory subsystem), and loaded and stored in the FPGA fabric (e.g., using SRAM cells) each time the device is powered-up for configuration of the desired logic. Here, the digest value(s) are computed based on the configuration data stored in the separate non-volatile memory, and the check value is computed based on the digest value(s).

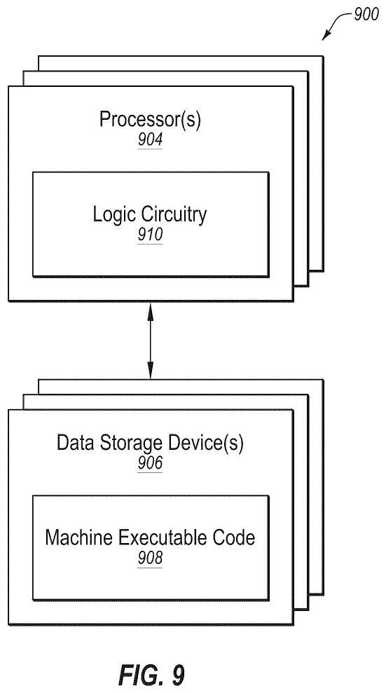

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 9 illustrates non-limiting examples of implementations of functional elements disclosed herein. In some examples, some or all portions of the functional elements disclosed herein may be performed by hardware specially implemented for carrying out the functional elements.

FIG. 9 is a block diagram of circuitry 900 that, in some examples, may be used to implement various functions, operations, acts, processes, and/or methods disclosed herein. In one or more examples, circuitry 900 may be included (in part, or in whole) in a computing device described herein. Circuitry 900 includes one or more processors 904 (sometimes referred to herein as “processors 904”) operably coupled to one or more data storage devices (sometimes referred to herein as “storage 906”). Storage 906 includes machine-executable code 908 stored thereon and processors 904 include logic circuitry 910. Machine-executable code 908 includes information describing functional elements that may be implemented by (e.g., performed by) logic circuitry 910. Logic circuitry 910 is adapted to implement (e.g., perform) the functional elements described by machine-executable code 908. Circuitry 900, when executing the functional elements described by machine-executable code 908, should be considered as special purpose hardware for carrying out functional elements disclosed herein. In some examples, processors 904 may perform the functional elements described by machine-executable code 908 sequentially, concurrently (e.g., on one or more different hardware platforms), or in one or more parallel process streams.

When implemented by logic circuitry 910 of processors 904, machine-executable code 908 adapts processors 904 to perform operations of examples disclosed herein. For example, machine-executable code 908 may be to adapt processors 904 to perform at least a portion or a totality of the methods or processes described herein.

Processors 904 may include a general purpose processor, a special purpose processor, a central processing unit (CPU), a microcontroller, a programmable logic controller (PLC), a digital signal processor (DSP), an ASIC, an FPGA or other programmable logic device, discrete gate or transistor logic, discrete hardware components, other programmable logic device, or any combination thereof designed to perform the functions disclosed herein. A general-purpose computer including a processor is considered a special-purpose computer while the general-purpose computer executes functional elements corresponding to machine-executable code 908 (e.g., software code, firmware code, hardware descriptions) related to examples of the present disclosure. It is noted that a general-purpose processor (may also be referred to herein as a host processor or simply a host) may be a microprocessor, but in the alternative, processors 904 may include any conventional processor, controller, microcontroller, or state machine. The processors 904 may also be implemented as a combination of computing devices, such as a combination of a DSP and a microprocessor, a plurality of microprocessors, one or more microprocessors in conjunction with a DSP core, or any other such configuration.

In some examples, storage 906 includes volatile data storage (e.g., random-access memory (RAM)), non-volatile data storage (e.g., Flash memory, a hard disc drive, a solid state drive, erasable programmable read-only memory (EPROM), etc.). In some examples, processors 904 and storage 906 may be implemented into a single device (e.g., a semiconductor device product, a system on chip (SOC), etc.). In some examples, processors 904 and storage 906 may be implemented into separate devices.

In some examples, machine-executable code 908 may include computer-readable instructions (e.g., software code, firmware code). By way of non-limiting example, the computer-readable instructions may be stored by storage 906, accessed directly by processors 904, and executed by processors 904 using at least logic circuitry 910. Also by way of non-limiting example, the computer-readable instructions may be stored on storage 906, transferred to a memory device (not shown) for execution, and executed by processors 904 using at least logic circuitry 910. Accordingly, in some examples, logic circuitry 910 includes electrically configurable logic circuitry 910.

In some examples, machine-executable code 908 may describe hardware (e.g., circuitry) to be implemented in logic circuitry 910 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of the logic circuitry 910 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 908 may include an HDL, an RTL, a GL description, a mask level description, other hardware description, or any combination thereof.

In examples where machine-executable code 908 includes a hardware description (at any level of abstraction), a system (not shown, but including storage 906) may be to implement the hardware description described by the machine-executable code 908. By way of non-limiting example, processors 904 may include a programmable logic device (e.g., an FPGA or a PLC) and logic circuitry 910 may be electrically controlled to implement circuitry corresponding to the hardware description into logic circuitry 910. Also by way of non-limiting example, logic circuitry 910 may include hard-wired logic manufactured by a manufacturing system (not shown, but including storage 906) according to the hardware description of machine-executable code 908.

Regardless of whether machine-executable code 908 includes computer-readable instructions or a hardware description, logic circuitry 910 is adapted to perform the functional elements described by machine-executable code 908 when implementing the functional elements of machine-executable code 908. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: An apparatus comprising: a programmable logic device including programmable logic elements, the programmable logic elements configurable to implement functions according to configuration data stored in non-volatile memory cells of the programmable logic elements, the programmable logic device to: store a digest value in memory, the digest value at least partially based on the configuration data stored in the non-volatile memory cells; perform an integrity check to verify whether a currently computed digest value matches the digest value, the currently computed digest value at least partially based on current configuration data stored in the non-volatile memory cells; read the digest value; determine a check value at least partially based on the digest value; and provide the check value at an output.

Example 2: The apparatus according to Example 1, wherein: the programmable logic device is to: perform the acts to read, to determine, and to provide at least partially responsive to a verification of a match between the currently computed digest value and the digest value; and refrain from performing the acts to read, to determine, and to provide at least partially responsive to a failure in the verification.

Example 3: The apparatus according to Examples 1 and 2, wherein the digest value is previously computed and stored at least partially responsive to a programming of the configuration data in the non-volatile memory cells.

Example 4: The apparatus according to any of Examples 1 to 3, wherein: the programmable logic device is to perform the integrity check including to: compute the currently computed digest value at least partially based on the current configuration data stored in the non-volatile memory cells.

Example 5: The apparatus according to any of Examples 1 to 4, wherein: the programmable logic device is to compute the currently computed digest value including to: compute a secure hash algorithm (SHA) value at least partially based on a SHA cryptographic hash function on the current configuration data stored in the non-volatile memory cells, the currently computed digest value comprising the SHA value.

Example 6: The apparatus according to any of Examples 1 to 5, wherein: the programmable logic device is to determine the check value including to: compute a cyclic redundancy check (CRC) value at least partially based on the digest value, the check value comprising or based on the CRC value.

Example 7: The apparatus according to any of Examples 1 to 6, wherein: the programmable logic device is to determine the check value including to: select one or more prespecified portions of the digest value, the check value comprising the selected one or more prespecified portions of the digest value.

Example 8: The apparatus according to any of Examples 1 to 7, wherein: the programmable logic device is to initiate the acts to perform, to read, to determine, and to provide at least partially responsive to: a power-up of the programmable logic device or a system including the programmable logic device.

Example 9: The apparatus according to any of Examples 1 to 8, wherein: the programmable logic device is to initiate the acts to perform, to read, to determine, and to provide at least partially responsive to: respective timeouts of a periodic timer of the programmable logic device; a signal received at an external pin of the programmable logic device; and/or an instruction of a communication received at a port of the programmable logic device.

Example 10: The apparatus according to any of Examples 1 to 9, wherein: the programmable logic device is to provide the check value at the output including to: provide the check value at the output for verification at a verification circuit.

Example 11: The apparatus according to any of Examples 1 to 10, wherein: the programmable logic device is configurable to implement the functions according to the configuration data stored in the non-volatile memory cells to operate or operate with an electronic circuitry or component of a system, the programmable logic device to: provide the check value at the output for verification at a verification circuit, the verification circuit including a comparator to compare the check value with a stored check value; operate or operate with the electronic circuitry or component of the system at least partially responsive to receiving an enable signal, the enable signal indicating verification of a match between the check value and the stored check value at the verification circuit; and refrain from operating or operating with the electronic circuitry or component of the system at least partially responsive to not receiving the enable signal.

Example 12: The apparatus according to any of Examples 1 to 11, wherein: the programmable logic device includes: a system controller; an input/output (I/O) interface including an I/O interface controller; a communication interface including a communication interface controller, the communication interface controller operably coupled to the system controller, the I/O interface coupled to the communication interface; the programmable logic device is to read the digest value including to: send a command, via the I/O interface and the communication interface coupled to the I/O interface, to the system controller, the command indicating to read data from the memory; receive the data in response to sending the command; and obtain the digest value from the received data.

Example 13: The apparatus according to any of Examples 1 to 12, wherein the programmable logic device comprises a Field-Programmable Gate Array (FPGA) or a programmable System-on-a-Chip (SoC), and the non-volatile memory comprises flash memory.

Example 14: A method comprising: at a programmable logic device including programmable logic elements configurable to implement functions according to configuration data stored in non-volatile memory cells of the programmable logic elements, storing a digest value in memory, the digest value at least partially based on the configuration data stored in the non-volatile memory cells; performing an integrity check to verify whether a currently computed digest value matches the digest value, the currently computed digest value at least partially based on current configuration data stored in the non-volatile memory cells; reading the digest value; determining a check value at least partially based on the digest value; and providing the check value at an output.

Example 15: The method according to Example 14, comprising: at the programmable logic device, performing the reading, the determining, and the providing at least partially responsive to a verification of a match between the currently computed digest value and the digest value; and refraining from performing the reading, the determining, and the providing at least partially responsive to a failure in the verification.

Example 16: The method according to Examples 14 and 15, wherein the integrity check comprises a tamper detection security feature of the programmable logic device, and performing the integrity check comprises: computing the currently computed digest value at least partially based on the current configuration data stored in the non-volatile memory cells.

Example 17: The method according to any of Examples 14 to 16, wherein computing the currently computed digest value comprises: computing a secure hash algorithm (SHA) value at least partially based on a SHA cryptographic hash function on the current configuration data stored in the non-volatile memory cells.

Example 18: The method according to any of Examples 14 to 17, wherein determining the check value comprises: calculating a cyclic redundancy check (CRC) value at least partially based on the digest value, the check value comprising or based on the CRC value.

Example 19: The method according to any of Examples 14 to 18, wherein determining the check value comprises: selecting one or more prespecified portions of the digest value, the check value comprising the selected one or more prespecified portions of the digest value.

Example 20: The method according to any of Examples 14 to 19, comprising: at the programmable logic device, initiating the performing, the reading, the determining, and the providing at least partially responsive to: a power-up of the programmable logic device or a system including the programmable logic device; and/or respective timeouts of a periodic timer of the programmable logic device.

Example 21: The method according to any of Examples 14 to 20, wherein providing the check value at the output comprises: providing the check value at the output for verification at a verification circuit, the verification circuit operably coupled to the programmable logic device.

Example 22: The method according to any of Examples 14 to 21, wherein the programmable logic device is configurable to implement the functions according to the configuration data stored in the non-volatile memory cells to operate or operate with an electronic circuitry or component of a system, the method comprising: at the programmable logic device: providing the check value at the output for verification; operating or operating with the electronic circuitry of the system at least partially responsive to receiving an enable signal, the enable signal indicating verification of a match between the check value and a stored check value; and refraining from operating or operating with the electronic circuitry or component of the system at least partially responsive to not receiving the enable signal.

Example 23: A system comprising: an electronic circuitry or component; a programmable logic device including programmable logic elements, the programmable logic elements configurable to implement functions according to configuration data stored in non-volatile memory cells to operate or operate with the electronic circuitry or component of the system, the programmable logic device including memory to store a digest value at least partially based on the configuration data stored in the non-volatile memory cells, the programmable logic device to initiate the following acts at least partially responsive to a power-up of the programmable logic device: perform an integrity check to verify whether a currently computed digest value matches the digest value stored in memory, the currently computed digest value at least partially based on current configuration data stored in the non-volatile memory cells; read the digest value; determine a check value at least partially based on the digest value; and provide the check value at an output; and a verification circuit operably coupled to the programmable logic device, the verification circuit to: compare the check value and a stored check value; and provide an enable signal at an output at least partially responsive to a match between the check value and the stored check value, the enable signal to enable operation of at least one of the programmable logic device and the electronic circuitry or component.

Example 24: The system according to Example 23, wherein: the programmable logic device is to: perform the acts to read, to determine, and to provide at least partially responsive to a verification of a match between the currently computed digest value and the digest value; and refrain from performing at least the act to provide at least partially responsive to a failure in the verification.

Example 25: The system according to Examples 23 and 24, wherein: the programmable logic device is to perform the integrity check including to: compute the currently computed digest value at least partially based on the current configuration data stored in the non-volatile memory cells.

Example 26: The system according to any of Examples 23 to 25, wherein: the programmable logic device is to compute the currently computed digest value including to: compute a secure hash algorithm (SHA) 256-bit (SHA-256) value at least partially based on a SHA-256 cryptographic hash function on the current configuration data stored in the non-volatile memory cells, the check value comprising the SHA-256 value.

Example 27: The system according to any of Examples 23 to 26, wherein: the programmable logic device is to determine the check value including to: compute a cyclic redundancy check (CRC) value from the digest value, the check value comprising the CRC value.

Example 28: The system according to any of Examples 23 to 27, wherein: the programmable logic device is to determine the check value including to: select one or more prespecified portions of the digest value, the check value comprising the selected one or more prespecified portions of the digest value.

Example 29: The system according to any of Examples 23 to 28, wherein: the programmable logic device is to: initiate the acts to perform, to read, to determine, and to provide at least partially responsive to respective timeouts of a periodic timer of the programmable logic device.

Example 30: The system according to any of Examples 23 to 29, wherein: the programmable logic device includes: a system controller; an input/output (I/O) interface including an I/O interface controller; a communication interface including a communication interface controller, the communication interface controller operably coupled to the system controller, the I/O interface coupled to the communication interface; the programmable logic device is to read the digest value including to: send a command, via the I/O interface and the communication interface coupled to the I/O interface, to the system controller, the command indicating to read data from the memory; receive the data in response to sending the command; and obtain the digest value from the received data.

Example 31: The system according to any of Examples 23 to 30, wherein the programmable logic device comprises a Field-Programmable Gate Array (FPGA) or a programmable System-on-a-Chip (SoC), and the non-volatile memory comprises flash memory.

Example 32: The system according to any of Examples 23 to 31, wherein the programmable logic device and the verification circuit operate in compliance with a Joint Ordinance Test Procedure (JOTP) 051 (JOTP-051) Technical Manual.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a programmable logic device including programmable logic elements, the programmable logic elements configurable to implement functions according to configuration data stored in non-volatile memory cells of the programmable logic elements, the programmable logic device to:
store a digest value in memory, the digest value at least partially based on the configuration data stored in the non-volatile memory cells;
perform an integrity check to verify whether a currently computed digest value matches the digest value, the currently computed digest value at least partially based on current configuration data stored in the non-volatile memory cells;
read the digest value;
determine a check value at least partially based on the digest value; and
provide the check value at an output.

2. The apparatus of claim 1, wherein:
the programmable logic device is to:
perform the acts to read, to determine, and to provide at least partially responsive to a verification of a match between the currently computed digest value and the digest value; and
refrain from performing the acts to read, to determine, and to provide at least partially responsive to a failure in the verification.

3. The apparatus of claim 1, wherein the digest value is previously computed and stored at least partially responsive to a programming of the configuration data in the non-volatile memory cells.

4. The apparatus of claim 3, wherein:
the programmable logic device is to perform the integrity check including to:
compute the currently computed digest value at least partially based on the current configuration data stored in the non-volatile memory cells.

5. The apparatus of claim 4, wherein:
the programmable logic device is to compute the currently computed digest value including to:
compute a secure hash algorithm (SHA) value at least partially based on a SHA cryptographic hash function on the current configuration data stored in the non-volatile memory cells, the currently computed digest value comprising the SHA value.

6. The apparatus of claim 1, wherein:
the programmable logic device is to determine the check value including to:
compute a cyclic redundancy check (CRC) value at least partially based on the digest value, the check value comprising or based on the CRC value.

7. The apparatus of claim 1, wherein:
the programmable logic device is to determine the check value including to:
select one or more prespecified portions of the digest value, the check value comprising the selected one or more prespecified portions of the digest value.

8. The apparatus of claim 1, wherein:
the programmable logic device is to initiate the acts to perform, to read, to determine, and to provide at least partially responsive to:
a power-up of the programmable logic device or a system including the programmable logic device.

9. The apparatus of claim 1, wherein:
the programmable logic device is to initiate the acts to perform, to read, to determine, and to provide at least partially responsive to:
respective timeouts of a periodic timer of the programmable logic device;
a signal received at an external pin of the programmable logic device; and/or
an instruction of a communication received at a port of the programmable logic device.

10. The apparatus of claim 1, wherein:
the programmable logic device is to provide the check value at the output including to:
provide the check value at the output for verification at a verification circuit.

11. The apparatus of claim 1, wherein:
the programmable logic device is configurable to implement the functions according to the configuration data stored in the non-volatile memory cells to operate or operate with an electronic circuitry or component of a system, the programmable logic device to:
provide the check value at the output for verification at a verification circuit, the verification circuit including a comparator to compare the check value with a stored check value;
operate or operate with the electronic circuitry or component of the system at least partially responsive to receiving an enable signal, the enable signal indicating verification of a match between the check value and the stored check value at the verification circuit; and
refrain from operating or operating with the electronic circuitry or component of the system at least partially responsive to not receiving the enable signal.

12. The apparatus of claim 1, wherein:
the programmable logic device includes:
a system controller;
an input/output (I/O) interface including an I/O interface controller;
a communication interface including a communication interface controller, the communication interface controller operably coupled to the system controller, the I/O interface coupled to the communication interface;
the programmable logic device is to read the digest value including to:
send a command, via the I/O interface and the communication interface coupled to the I/O interface, to the system controller, the command indicating to read data from the memory;
receive the data in response to sending the command; and
obtain the digest value from the received data.

13. The apparatus of claim 1, wherein the programmable logic device comprises a Field-Programmable Gate Array (FPGA) or a programmable System-on-a-Chip (SoC), and the non-volatile memory comprises flash memory.

14. A method comprising:
at a programmable logic device including programmable logic elements configurable to implement functions according to configuration data stored in non-volatile memory cells of the programmable logic elements,
storing a digest value in memory, the digest value at least partially based on the configuration data stored in the non-volatile memory cells;
performing an integrity check to verify whether a currently computed digest value matches the digest value, the currently computed digest value at least partially based on current configuration data stored in the non-volatile memory cells;
reading the digest value;
determining a check value at least partially based on the digest value; and
providing the check value at an output.

15. The method of claim 14, comprising:
at the programmable logic device,
performing the reading, the determining, and the providing at least partially responsive to a verification of a match between the currently computed digest value and the digest value; and
refraining from performing the reading, the determining, and the providing at least partially responsive to a failure in the verification.

16. The method of claim 15, wherein the integrity check comprises a tamper detection security feature of the programmable logic device, and performing the integrity check comprises:
computing the currently computed digest value at least partially based on the current configuration data stored in the non-volatile memory cells.

17. The method of claim 16, wherein computing the currently computed digest value comprises:
computing a secure hash algorithm (SHA) value at least partially based on a SHA cryptographic hash function on the current configuration data stored in the non-volatile memory cells.

18. The method of claim 17, wherein determining the check value comprises:
calculating a cyclic redundancy check (CRC) value at least partially based on the digest value, the check value comprising or based on the CRC value.

19. The method of claim 17, wherein determining the check value comprises:
selecting one or more prespecified portions of the digest value, the check value comprising the selected one or more prespecified portions of the digest value.

20. The method of claim 17, comprising:
at the programmable logic device,
initiating the performing, the reading, the determining, and the providing at least partially responsive to:
a power-up of the programmable logic device or a system including the programmable logic device; and/or
respective timeouts of a periodic timer of the programmable logic device.

21. The method of claim 17, wherein providing the check value at the output comprises:
providing the check value at the output for verification at a verification circuit, the verification circuit operably coupled to the programmable logic device.

22. The method of claim 21, wherein the programmable logic device is configurable to implement the functions according to the configuration data stored in the non-volatile memory cells to operate or operate with an electronic circuitry or component of a system, the method comprising:
at the programmable logic device:
providing the check value at the output for verification;
operating or operating with the electronic circuitry of the system at least partially responsive to receiving an enable signal, the enable signal indicating verification of a match between the check value and a stored check value; and
refraining from operating or operating with the electronic circuitry or component of the system at least partially responsive to not receiving the enable signal.

23. A system comprising:
an electronic circuitry or component;
a programmable logic device including programmable logic elements, the programmable logic elements configurable to implement functions according to configuration data stored in non-volatile memory cells to operate or operate with the electronic circuitry or component of the system, the programmable logic device including memory to store a digest value at least partially based on the configuration data stored in the non-volatile memory cells, the programmable logic device to initiate the following acts at least partially responsive to a power-up of the programmable logic device:
perform an integrity check to verify whether a currently computed digest value matches the digest value stored in memory, the currently computed digest value at least partially based on current configuration data stored in the non-volatile memory cells;
read the digest value;
determine a check value at least partially based on the digest value; and
provide the check value at an output; and
a verification circuit operably coupled to the programmable logic device, the verification circuit to:
compare the check value and a stored check value; and
provide an enable signal at an output at least partially responsive to a match between the check value and the stored check value, the enable signal to enable operation of at least one of the programmable logic device and the electronic circuitry or component.

24. The system of claim 23, wherein:
the programmable logic device is to:
perform the acts to read, to determine, and to provide at least partially responsive to a verification of a match between the currently computed digest value and the digest value; and
refrain from performing at least the act to provide at least partially responsive to a failure in the verification.

25. The system of claim 23, wherein:
the programmable logic device is to perform the integrity check including to:
compute the currently computed digest value at least partially based on the current configuration data stored in the non-volatile memory cells.

26. The system of claim 25, wherein:
the programmable logic device is to compute the currently computed digest value including to:
compute a secure hash algorithm (SHA) 256-bit (SHA-256) value at least partially based on a SHA-256 cryptographic hash function on the current configuration data stored in the non-volatile memory cells, the check value comprising the SHA-256 value.

27. The system of claim 26, wherein:
the programmable logic device is to determine the check value including to:
compute a cyclic redundancy check (CRC) value from the digest value, the check value comprising the CRC value.

28. The system of claim 26, wherein:
the programmable logic device is to determine the check value including to:
select one or more prespecified portions of the digest value, the check value comprising the selected one or more prespecified portions of the digest value.

29. The system of claim 23, wherein:
the programmable logic device is to:
initiate the acts to perform, to read, to determine, and to provide at least partially responsive to respective timeouts of a periodic timer of the programmable logic device.

30. The system of claim 23, wherein:
the programmable logic device includes:
a system controller;
an input/output (I/O) interface including an I/O interface controller;
a communication interface including a communication interface controller, the communication interface controller operably coupled to the system controller, the I/O interface coupled to the communication interface;
the programmable logic device is to read the digest value including to:
send a command, via the I/O interface and the communication interface coupled to the I/O interface, to the system controller, the command indicating to read data from the memory;
receive the data in response to sending the command; and
obtain the digest value from the received data.

31. The system of claim 23, wherein the programmable logic device comprises a Field-Programmable Gate Array (FPGA) or a programmable System-on-a-Chip (SoC), and the non-volatile memory comprises flash memory.

32. The system of claim 23, wherein the programmable logic device and the verification circuit operate in compliance with a Joint Ordinance Test Procedure (JOTP) 051 (JOTP-051) Technical Manual.
